(19) United States
(12) Patent Application Publication
(10) Pub. No.: US 2025/0262636 A1
(43) Pub. Date: Aug. 21, 2025

(54) FLUID SPRAY TIPS HAVING SECURING ELEMENTS FORMED IN THE FLUID SPRAY TIP BODY AND METHODS OF MANUFACTURING THEREOF

(71) Applicant: Wagner Spray Tech Co., Plymouth, MN (US)

(72) Inventors: Brian Lee FIDELER, Jordan, MN (US); Christopher J. SULZER, St. Louis Park, MN (US); Joseph W. KIEFFER, Chanhassen, MN (US); Mason PASS, Crystal, MN (US)

(21) Appl. No.: 19/188,309

(22) Filed: Apr. 24, 2025

Related U.S. Application Data
(63) Continuation-in-part of application No. 18/440,268, filed on Feb. 13, 2024.
(60) Provisional application No. 63/486,274, filed on Feb. 22, 2023.

(51) Int. Cl. B05B 15/658; B05B 9/01

(52) U.S. Cl. CPC B05B 15/658; B05B 9/01

(57) ABSTRACT

A spray tip includes a tip body having a longitudinal axis and a receiving channel extending between a front and back of the tip body transverse to the longitudinal axis. The spray tip further includes a tip piece defining, at least, a first portion of a fluid channel, the fluid channel extending between an inlet and an outlet. The spray tip further includes a first securing element downstream of at least a portion of the tip piece and a second securing element upstream of the tip piece. The first securing element and the second securing element securing at least the tip piece within the receiving channel.

### CROSS-REFERENCE TO RELATED APPLICATION

The present application is a continuation-in-part of and claims priority of U.S. patent application Ser. No. 18/440,268, filed Feb. 13, 2024, which is based on and claims the benefit of U.S. Provisional Patent Application Ser. No. 63/486,274, filed on Feb. 22, 2023; the contents of these applications are hereby incorporated by reference in their entirety.

### BACKGROUND

Spray tips are typically used in a variety of applications to break up, or atomize, a fluid material for delivery in a desired spray pattern.

While examples described herein are in the context of applying paint to a surface, it is understood that the concepts are not limited to these particular applications. As used herein, paint includes substances composed of coloring matter, or pigments, suspended in a liquid medium as well as substances that are free of coloring matter or pigment. Paint may also include preparatory coatings, such as primers, and can be opaque, transparent, or semi-transparent. Some particular examples include, but are not limited to, latex paint, oil-based paint, stain, lacquers, varnishes, inks, etc.

The discussion above is merely provided for general background information and is not intended to be used as an aid in determining the scope of the claimed subject matter.

### SUMMARY

A spray tip includes a tip body having a longitudinal axis and a receiving channel extending between a front and back of the tip body transverse to the longitudinal axis. The spray tip further includes a tip piece defining, at least, a first portion of a fluid channel, the fluid channel extending between an inlet and an outlet. The spray tip further includes a first securing element downstream of at least a portion of the tip piece and a second securing element upstream of the tip piece. The first securing element and the second securing element securing at least the tip piece within the receiving channel.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a perspective view showing one example fluid application system.

FIG. 2 is a side view showing one example fluid applicator.

FIG. 3 is a perspective view showing one example spray tip.

FIG. 4 is a partial front view showing one example spray tip.

FIGS. 5A and 5B are sectional views showing one example spray tip.

FIGS. 6A and 6B are sectional views showing one example spray tip.

FIGS. 7A and 7B are sectional views showing one example spray tip.

FIGS. 8A and 8B are sectional views showing one example spray tip.

FIGS. 9A and 9B are sectional views showing one example spray tip.

FIGS. 10A and 10B are sectional views showing one example spray tip.

FIGS. 11A and 11B are sectional views showing one example spray tip.

FIGS. 12A and 12B are sectional views showing one example spray tip.

FIGS. 13A and 13B are sectional views showing one example spray tip.

FIGS. 14A and 14B are sectional views showing one example spray tip.

FIGS. 15A and 15B are sectional views showing one example spray tip.

FIGS. 16A and 16B are sectional views showing one example spray tip.

FIG. 17 is a block diagram showing one example fluid application system in more detail.

FIG. 18 is a flowchart showing one example method of manufacturing a spray tip.

### DETAILED DESCRIPTION OF THE DRAWINGS

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

In a fluid application system, a pump receives and pressurizes a fluid, delivers the pressurized fluid to an applicator, which, in turn, applies the pressurized fluid to a surface using a spray tip having a geometry selected to emit a desired spray pattern (e.g., a round pattern, a flat pattern, or a fan pattern, etc.). The fluid may comprise any fluid applied to surfaces, including, but not limited to, for example, paint, primer, lacquers, foams, textured materials, plural components, adhesive components, etc.

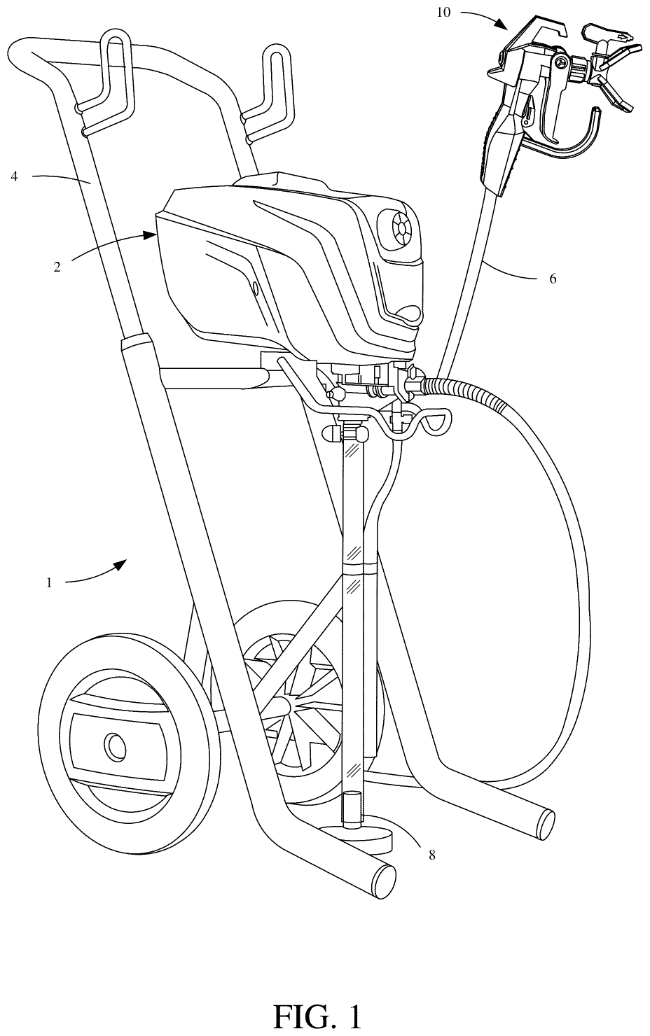

FIG. 1 is a perspective view showing one example fluid application system 1. Fluid application system 1, illustratively shown as an airless fluid spraying system (e.g., a high efficiency airless spraying system), includes pump 2 that is mounted on a cart 4 and couples to applicator 10 through fluid delivery line 6 (e.g., a hose). Pump 2 includes a fluid intake 8 that is disposed within a fluid source (e.g., a five-gallon bucket of paint). Pump 2 pumps the fluid from the fluid source through fluid intake 8 and pumps the fluid at a given pressure to applicator 10 through fluid delivery line 6. In one example, pump 2 can pressurize the fluid between 1500-3500 PSI.

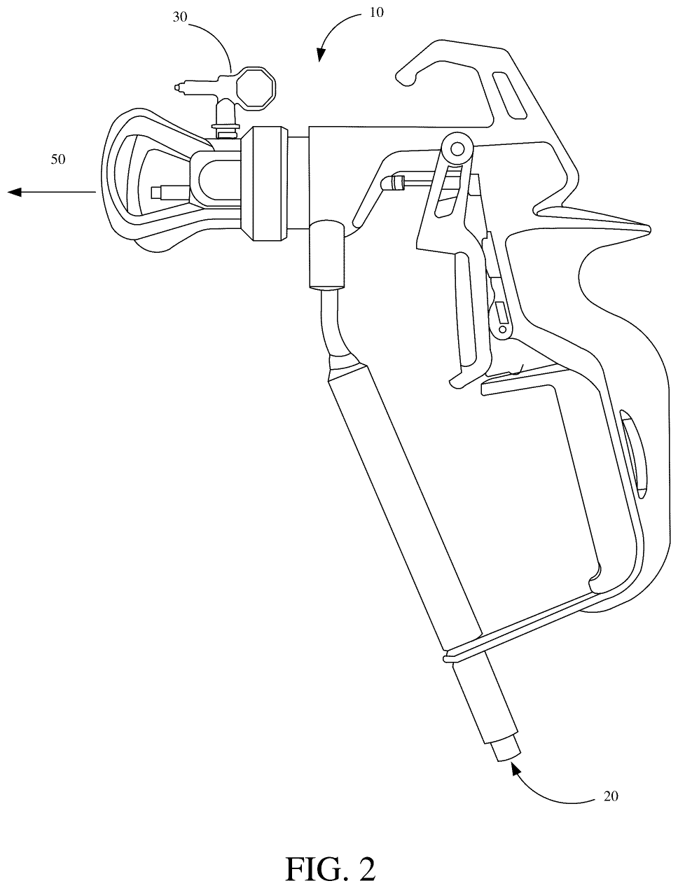

FIG. 2 is a side view showing an example applicator 10. Applicator 10 is used in a fluid spraying system (e.g., fluid application system 1) to apply fluid to a surface (e.g., apply paint to a wall). The fluid enters through inlet 20, and exits from outlet 50, after passing through a fluid channel (not explicitly shown) within applicator 10. Fluid inlet 20 may be coupled to a fluid delivery line, such as fluid delivery line 6. Tip 30 is coupled to applicator 10 and has an outlet 50. Tip 30 often is reversible (e.g., tip 30 can be rotated around its longitudinal axis such that the inlet and outlet are flipped in position (i.e., inlet facing away from applicator 10 and outlet facing towards applicator 10)) or removable from applicator 10. The reversibility of spray tip 30 can help with cleaning.

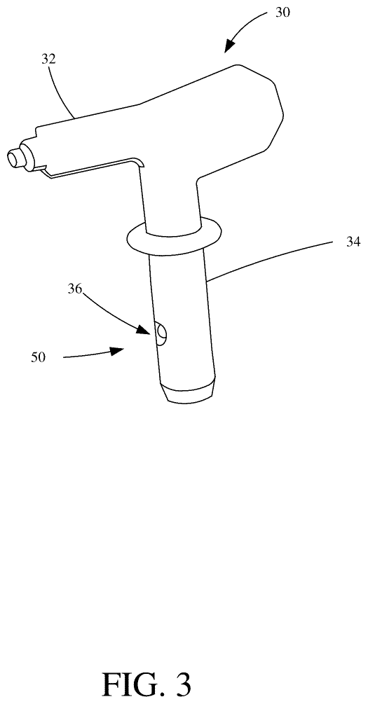

FIG. 3 is a perspective view showing an example spray tip 30. Spray tip 30 includes flag 32, tip stem 34, and receiving channel 36. Flag 32 can be coupled to tip stem 34 in various ways including, for example, but not by limitation, press fitting flag onto tip stem 34 or over molding flag 32 onto tip stem 34. Flag 32 provides a convenient surface for handling spray tip 30, particularly when spray tip 30 is installed in an applicator and can be used to indicate the directionality of spray tip 30. Flag 32 can comprise various materials, for example, polymer. Tip stem 34 can comprise various materials, for example, metal such as stainless steel. A receiving channel 36 can be provided through tip stem 34, such as by machining, cutting, etc. The receiving channel 36 extends a distance between a front of spray tip 30 and a rear (or back) of spray tip 30. In some examples, the receiving channel 36 may extend from a front of spray tip 30 to a rear of spray tip 30 and yet, in other examples, the receiving channel 36 may extend some other distance. The receiving channel 36 will be shown in more detail below.

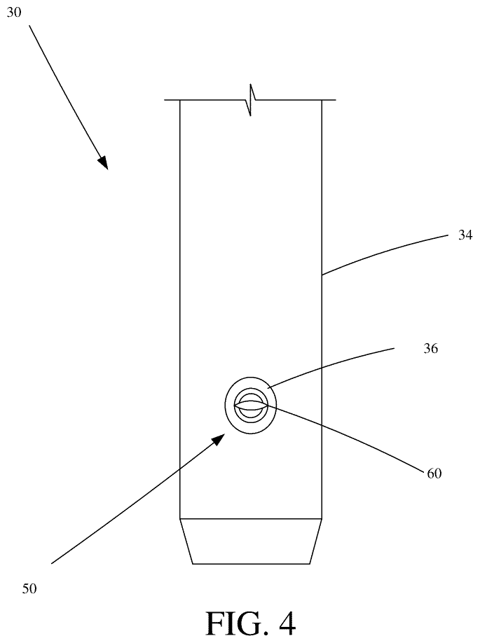

FIG. 4 is a partial front view showing example spray tip 30. As illustrated in FIG. 4, a tip piece 60 can be placed and retained within receiving channel 36. As will be shown in more detail in figures below, various other items can be placed and retained within a receiving channel of a spray tip.

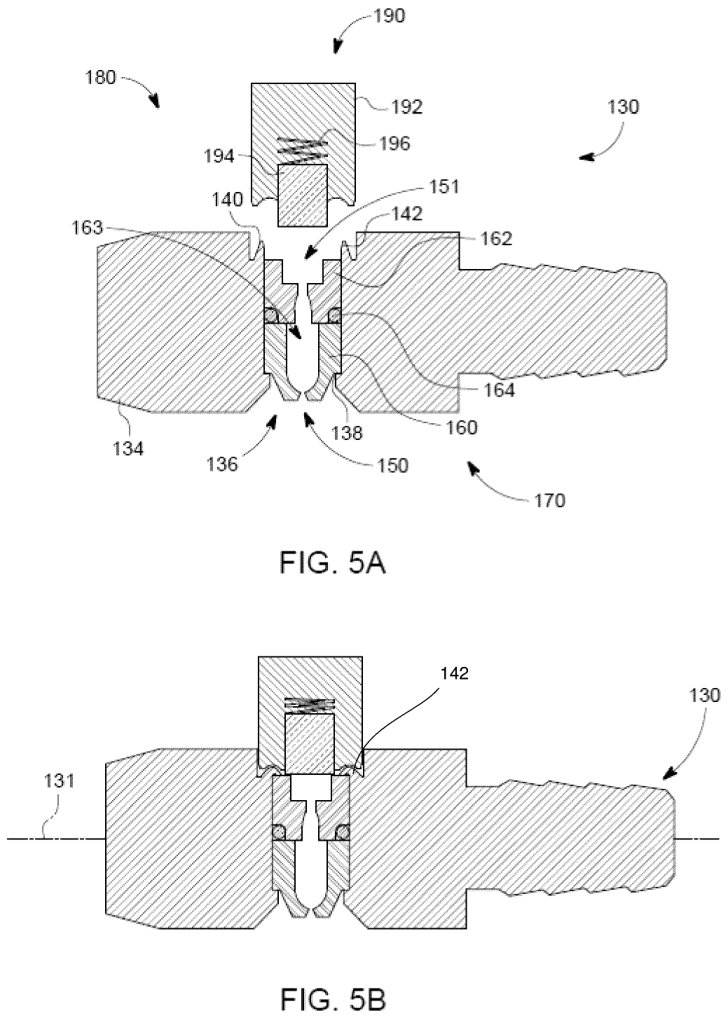

FIGS. 5A-16B are cross-sectional views showing example spray tips. It will be understood that the spray tips illustrated in FIGS. 5A-16B are example embodiments of spray tip 30 and can thus be used with a fluid applicator, such as fluid applicator 10, and in a fluid applicator system, such as fluid application system 1. It will be noted that the example spray tips shown in FIGS. 5A-16B have their respective flags removed for convenience of illustration, but it will be understood that each of the example spray tips can include a flag, such as flag 32.

FIGS. 5A and 5B (collectively referred to herein as FIG. 5) are cross-sectional views showing example spray tip 130. As illustrated in FIG. 5, spray tip 130 includes tip stem 134 with a receiving channel 136 provided therein, transverse to the longitudinal axis 131 of the tip stem 134. Receiving channel 136 extends between a front 170 of spray tip 130 and a back 180 of spray tip 130. It can be seen in FIG. 5 that a tip piece 160, a pre-orifice element in the form of a pre-orifice piece 162, and a sealing element 164 are placed within receiving channel 136 from the back 180 of spray tip 130 and are retained within receiving channel 136. The geometry of receiving channel 136 forms a shoulder 138 against which an outer surface of tip piece 160 abuts. Sealing element 164 (illustratively an O-ring) fits around pre-orifice piece 162 (a portion of pre-orifice piece 162 is disposed within a hole of sealing element 164). Sealing element 164 abuts an outer surface of pre-orifice piece 162, an outer surface of tip piece 160, and a wall of receiving channel 136. An outer surface of pre-orifice piece 162 abuts an outer surface of tip piece 160. Tip piece 160 and pre-orifice piece 162 form a fluid channel 163 having variable geometry extending from an inlet 151 to an outlet 150. Fluid, to be sprayed, is received though the inlet 151 and exits through the outlet 150. A recess 140 is provided from and in to the back 180 of spray tip 130 which forms an annular projection 142.

A swaging tool 190 is provided. Swaging tool 190 includes a swaging body 192, a biased member 194, and a biasing member 196. In the illustrated example, biasing member 196 is a spring. Swaging tool 190 is pressed, from the back 180 of spray tip 130, against spray tip 130 such that biased member 194 contacts pre-orifice portion 162, and such that swaging body 192 fits within recess 140 and contacts annular projection 142 to deform (or crimp) annular projection 142 against pre-orifice piece 162. Biased member 194 contacts pre-orifice portion 162 and drives pre-orifice portion 162 to and against sealing element 164 and thereby crushes sealing element 164 such that sealing element 164 forms a seal against an outer surface of pre-orifice piece 162, a seal against an outer surface of tip piece 160, and a seal against a wall of receiving channel 136. The deformed annular projection 142 (shown in FIG. 5B) and the shoulder 138 retain pre-orifice portion 162, sealing element 164, and tip piece 160 within receiving channel 136.

In one example, tip piece 160 can be formed of a metal, such as carbide. In one example, pre-orifice piece 162 can be formed of a metal, such as carbide or stainless steel, such as hardened stainless steel. In one example, sealing element 164 can be formed of a polymer, such as an elastomer (e.g., rubber, etc.).

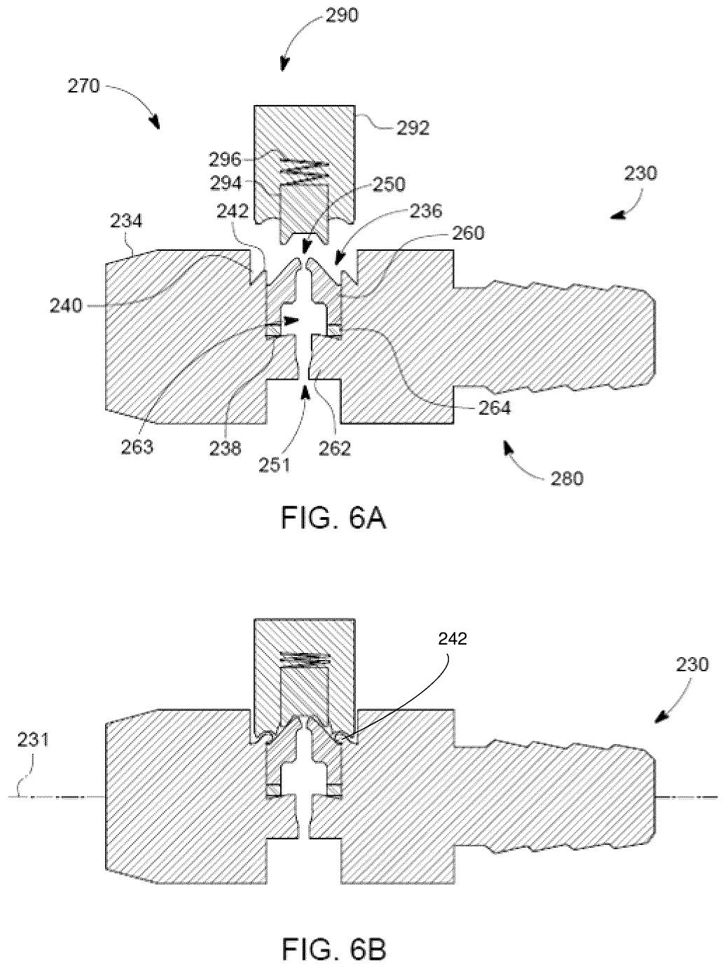

FIGS. 6A and 6B (collectively referred to herein as FIG. 6) are cross-sectional views showing example spray tip 230. As illustrated in FIG. 6, spray tip 230 includes tip stem 234 with a receiving channel 236 provided therein, transverse to the longitudinal axis 231 of the tip stem 234. Receiving channel 236 extends from a front 270 to a pre-orifice element in the form of a pre-orifice portion 262. Pre-orifice portion 262 is formed within tip stem 234, such as by machining, and includes a shoulder 238. It can be seen in FIG. 6 that a tip piece 260 and a sealing element 264 are placed within receiving channel 236 from the front 270 of spray tip 230 and are retained within receiving channel 236. Sealing element 264 (illustratively a gasket) abuts shoulder 238, an outer surface of tip piece 260, and a wall of receiving channel 236. Tip piece 260, pre-orifice portion 262, and sealing element 264 form a fluid channel 263 having variable geometry extending from an inlet 251 to an outlet 250. Fluid, to be sprayed, is received through inlet 251 and exits through outlet 250. A recess 240 is provided from and in the front 270 of spray tip 230 which forms an annular projection 242.

A swaging tool 290 is provided. Swaging tool 290 includes a swaging body 292, a biased member 294, and a biasing member 296. In the illustrated example, biasing member 296 is a spring. Swaging tool 290 is pressed, from the front 270 of spray tip 230, against spray tip 230 such that biased member 294 contacts tip piece 260 and such that swaging body 292 fits within recess 240 and contacts annular projection 242 to deform (or crimp) annular projection 242 against tip piece 260. Biased member 294 contacts tip piece 260 and drives tip piece 260 to and against sealing element 264 and thereby crushes sealing element 264 such that sealing element 264 forms a seal against an outer surface or tip piece 260, a seal against shoulder 238, and a seal against a wall of receiving channel 236. The deformed annular projection 242 (shown in FIG. 6B) and shoulder 238 retain tip piece 260 and sealing element 264 within receiving channel 236. As can be seen in FIG. 6, biased member 294 is shaped to accommodate a portion of tip piece 260.

In one example, tip piece 260 can be formed of a metal, such as carbide. In one example, pre-orifice portion 262 (as well as tip stem 234) can be formed of stainless steel, such as hardened stainless steel. In one example, sealing element 264 can be formed of a polymer, such as plastic or an elastomer (e.g., rubber, etc.).

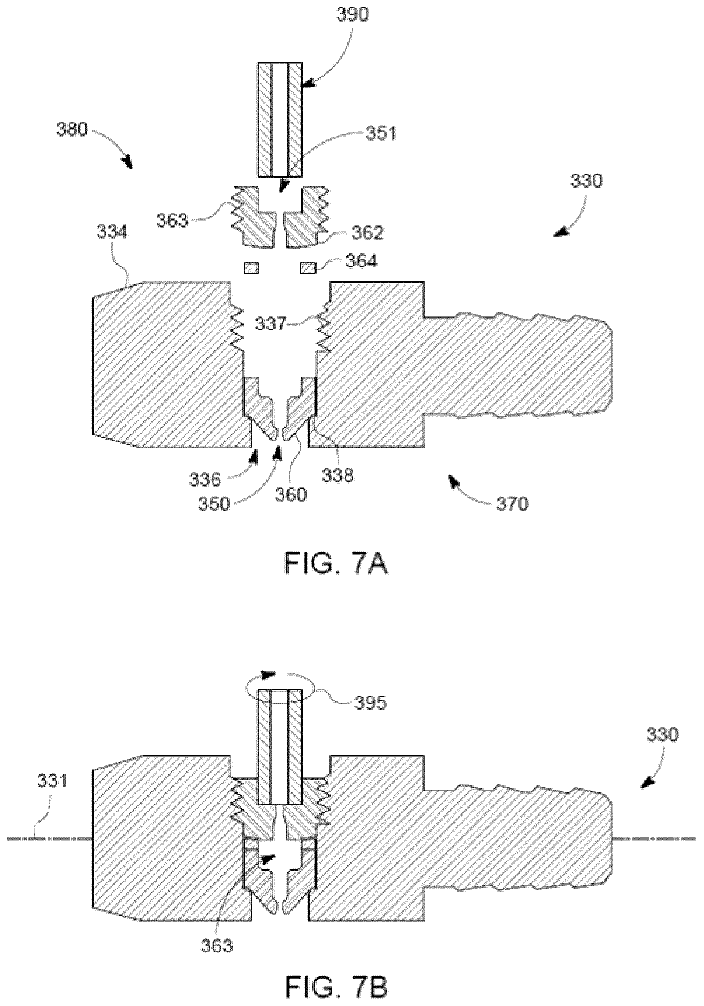

FIGS. 7A and 7B (collectively referred to herein as FIG. 7) are cross-sectional views showing example spray tip 330. As illustrated in FIG. 7, spray tip 330 includes tip stem 334 with a receiving channel 336 provided therein, transverse to the longitudinal axis 331 of the tip stem 334. Receiving channel 336 extends between a front 370 of spray tip 330 and a back 380 of spray tip 330. It can be seen in FIG. 7 that a tip piece 360, a pre-orifice element in the form of a pre-orifice piece 362, and a sealing element 364 are placed within receiving channel 336 from the back 380 of spray tip 330 and are retained within receiving channel 336. The geometry of receiving channel 336 forms a shoulder 338 against which an outer surface of tip piece 360 abuts. Sealing element 364 (illustratively a gasket) abuts an outer surface of pre-orifice piece 362, an outer surface of tip piece 360, and a wall of receiving channel 336. Tip piece 360, pre-orifice portion 362, and sealing element 364 form a fluid channel 363 having variable geometry extending from an inlet 351 to an outlet 350. Fluid, to be sprayed, is received though the inlet 351 and exits through the outlet 350. As can be seen in FIG. 7, receiving channel 336 is provided with threads 337 and pre-orifice piece 362 is provided with threads 363. Threads 363 and threads 337 mate.

A rotatable driving tool 390 is provided. In the illustrated example, rotatable driving tool 390 is provided, from the back 380 of spray tip 330, and into the fluid channel of pre-orifice piece 362. Rotatable driving tool 390, while disposed within the fluid channel of pre-orifice piece 362, is rotated, as indicated by arrow 395, to drive pre-orifice piece 362 within receiving channel 336, via threads 363 and 337, towards sealing element 364 and to contact and crush sealing element 364 such that sealing element 364 forms a seal against an outer surface of pre-orifice piece 362, a seal against an outer surface of tip piece 360, and a seal against a wall of receiving channel 336. The threaded connection between pre-orifice piece 362 and receiving channel 336 (shown in FIG. 7B) retains pre-orifice piece 362 within receiving channel 336. Thus, tip piece 360, pre-orifice portion 362, and sealing element 364 are retained within receiving channel 336 by shoulder 338 and the threaded connection between pre-orifice piece 362 and receiving channel 336 (as shown in FIG. 7B).

In one example, tip piece 360 can be formed of a metal, such as carbide. In one example, pre-orifice piece 362 can be formed of a metal, such as stainless steel, for instance hardened stainless steel. In one example, pre-orifice piece 362 is a set screw, such as a hardened stainless steel set screw. In one example, sealing element 364 can be formed of a polymer, such as plastic or an elastomer (e.g., rubber, etc.).

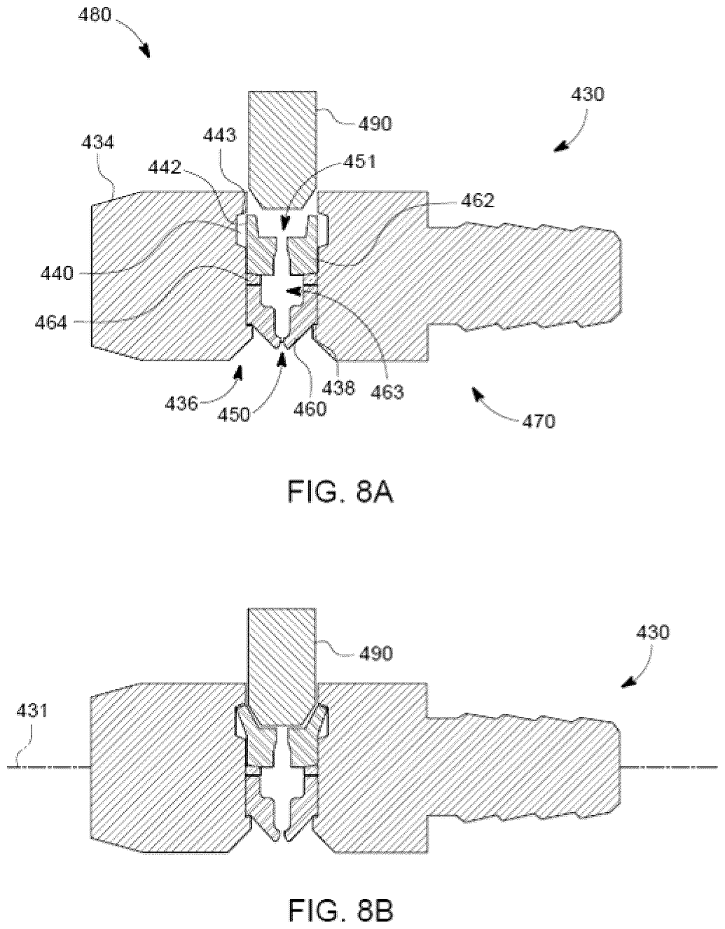

FIGS. 8A and 8B (collectively referred to herein as FIG. 8) are cross-sectional views showing example spray tip 430. As illustrated in FIG. 8, spray tip 430 includes tip stem 434 with a receiving channel 436 provided therein, transverse to the longitudinal axis 431 of the tip stem 434. Receiving channel 436 extends between a front 470 of spray tip 430 and a back 480 of spray tip 430. It can be seen in FIG. 8 that a tip piece 460, a pre-orifice element in the form of a pre-orifice piece 462, and a sealing element 464 are placed within receiving channel 436 from the back 480 of spray tip 430 and are retained within receiving channel 436. The geometry of receiving channel 436 forms a shoulder 438 against which an outer surface of tip piece 460 abuts. Sealing element 464 (illustratively a gasket) abuts an outer surface of pre-orifice piece 462, an outer surface of tip piece 460, and a wall of receiving channel 436. Tip piece 460, pre-orifice portion 462, and sealing element 464 form a fluid channel 463 having variable geometry extending from an inlet 451 to an outlet 450. Fluid, to be sprayed, is received though the inlet 451 and exits through the outlet 450. As can be seen in FIG. 8, tip stem 434 is provided with a recess 440 that extends radially from receiving channel 436 and forms a shoulder 443.

A press tool 490 is provided. In the illustrated example, press tool 490 is provided, from the back 480 of spray tip 430, and into the fluid channel of pre-orifice piece 462. Press tool 490, while disposed within the fluid channel of pre-orifice piece 462, is driven to press pre-orifice piece 462 towards and against sealing element 464 to crush sealing element 464 such that sealing element 464 forms a seal against an outer surface of pre-orifice piece 462, a seal against an outer surface of tip piece 460, and a seal against a wall of receiving channel 436. Insertion of the press tool 490 into the fluid channel of pre-orifice piece 462 deforms a wall 442 of pre-orifice piece 462 such that pre-orifice portion 462 expands in diameter and is disposed within recess 440 and abuts shoulder 443 (as shown in FIG. 8B). Thus, tip piece 460, pre-orifice portion 462, and sealing element 464 are retained within receiving channel 436 by shoulder 438 and the contact between the deformed wall 442 (shown in FIG. 8B) of pre-orifice piece 462 and the shoulder 443.

In one example, tip piece 460 can be formed of a metal, such as carbide. In one example, pre-orifice piece 462 can be formed of a metal, such as stainless steel. In one example, sealing element 464 can be formed of a polymer, such as plastic or an elastomer (e.g., rubber, etc.).

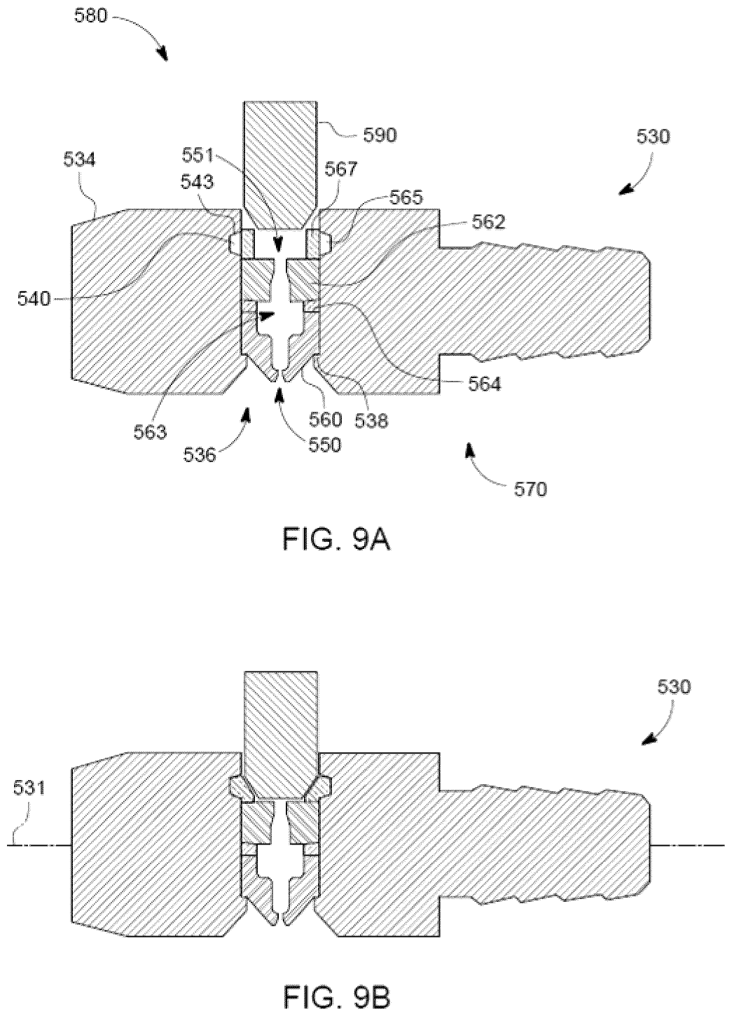

FIGS. 9A and 9B (collectively referred to herein as FIG. 9) are cross-sectional views showing example spray tip 530. As illustrated in FIG. 9, spray tip 530 includes tip stem 534 with a receiving channel 536 provided therein, transverse to the longitudinal axis 531 of the tip stem 534. Receiving channel 536 extends between a front 570 of spray tip 530 and a back 580 of spray tip 530. It can be seen in FIG. 9 that a tip piece 560, a pre-orifice element in the form of a pre-orifice piece 562, a sealing element 564, and a retaining ring 565 are placed within receiving channel 536 from the back 580 of spray tip 530 and are retained within receiving channel 536. The geometry of receiving channel 536 forms a shoulder 538 against which an outer surface of tip piece 560 abuts. Sealing element 564 (illustratively a gasket) abuts an outer surface of pre-orifice piece 562, an outer surface of tip piece 560, and a wall of receiving channel 536. Tip piece 560, pre-orifice portion 562, and sealing element 564 form a fluid channel 563 having variable geometry extending from an inlet 551 to an outlet 550. Fluid, to be sprayed, is received though the inlet 551 and exits through the outlet 550. As can be seen in FIG. 9, tip stem 534 is provided with a recess 540 which extends radially from receiving channel 536 and forms a shoulder 543. Retaining ring 565, when installed, abuts pre-orifice piece 562.

A press tool 590 is provided. In the illustrated example, press tool 590 is provided, from the back 580 of spray tip 530, and into a hole of retaining ring 565. Press tool 590, while disposed within the hole of retaining ring 565, is driven to press retaining ring 565 towards and against pre-orifice portion 562 which drives pre-orifice portion 562 towards and against sealing element 564 to crush sealing element 564 such that sealing element 564 forms a seal against an outer surface of pre-orifice piece 562, a seal against an outer surface of tip piece 560, and a seal against a wall of receiving channel 536. Insertion of the press tool 590 into the hole of retaining ring 565 deforms a wall 567 of retaining ring 565 such that retaining ring 565 expands in diameter and is disposed within recess 540 and abuts shoulder 543 (as shown in FIG. 9B). Thus, tip piece 560, pre-orifice portion 562, sealing element 564, and retaining ring 565 are retained within receiving channel 536 by shoulder 538 and the contact between the deformed wall 567 (shown in FIG. 9B) of retaining ring 565 and the shoulder 543.

In one example, tip piece 560 can be formed of a metal, such as carbide. In one example, pre-orifice piece 562 can be formed of a metal, such as carbide or stainless steel, such as hardened stainless steel. In one example, sealing element 564 can be formed of a polymer, such as plastic or an elastomer (e.g., rubber, etc.). In one example, retaining ring 565 can be formed of metal, such as stainless steel, for instance hardened stainless steel.

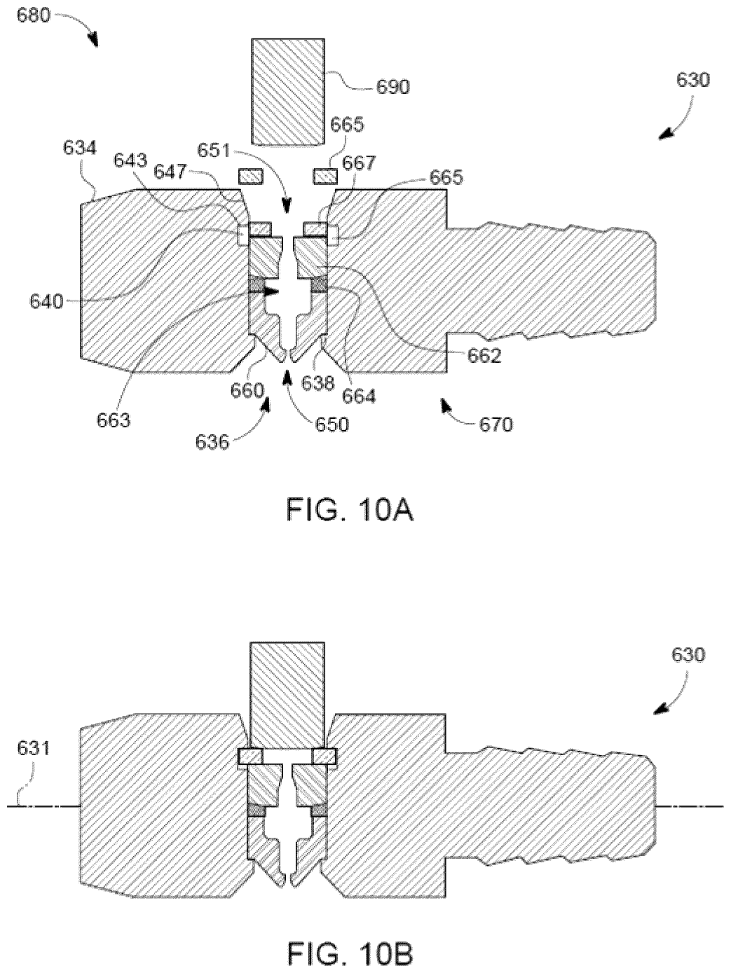

FIGS. 10A and 10B (collectively referred to herein as FIG. 10) are cross-sectional views showing one example spray tip 630. As illustrated in FIG. 10, spray tip 630 includes tip stem 634 with a receiving channel 636 provided therein, transverse to the longitudinal axis 631 of the tip stem 634. Receiving channel 636 extends between a front 670 of spray tip 630 and a back 680 of spray tip 630. It can be seen in FIG. 10 that a tip piece 660, a pre-orifice element in the form of a pre-orifice piece 662, a sealing element 664, and a snap ring 665 are placed within receiving channel 636 from the back 680 of spray tip 630 and are retained within receiving channel 636. The geometry of receiving channel 636 forms a shoulder 638 against which an outer surface of tip piece 660 abuts. Sealing element 664 (illustratively a gasket) abuts an outer surface of pre-orifice piece 662, an outer surface of tip piece 660, and a wall of receiving channel 636. Tip piece 660, pre-orifice portion 662, and sealing element 664 form a fluid channel 663 having variable geometry extending from an inlet 651 to an outlet 650. Fluid, to be sprayed, is received though the inlet 651 and exits through the outlet 650. As can be seen in FIG. 10, tip stem 634 is provided with a recess 640 which extends radially from receiving channel 636 and forms a shoulder 643. Receiving channel 636 further includes a ramp 647 which narrows as it extends from the back 680 of spray tip 630 towards the front 670 of spray tip 630. Snap ring 665, when installed, abuts pre-orifice piece 662.

A press tool 690 is provided. In the illustrated example, press tool 690 is provided, from the back 680 of spray tip 630, and into a hole of snap ring 665. Press tool 690, while disposed within the hole of snap ring 665, is driven to press and drive snap ring 665 along ramp 647 towards and against pre-orifice portion 662 which drives pre-orifice portion 662 towards and against sealing element 664 to crush sealing element 664 such that sealing element 664 forms a seal against an outer surface of pre-orifice piece 662, a seal against an outer surface of tip piece 660, and a seal against a wall of receiving channel 636. Driving snap ring 665 along ramp 647 progressively reduces the diameter of snap ring 665 until snap ring 665 passes ramp 647 at which point snap ring 665 snaps back to its original (or at least a wider) diameter and is thus disposed within recess 640 and abuts shoulder 643 (as shown in FIG. 10B). Thus, tip piece 660, pre-orifice portion 662, sealing element 664, and snap ring 665 are retained within receiving channel 636 by shoulder 638 and the contact between snap ring 665 and the shoulder 643.

In one example, tip piece 660 can be formed of a metal, such as carbide. In one example, pre-orifice piece 662 can be formed of a metal, such as carbide or stainless steel, such as hardened stainless steel. In one example, sealing element 664 can be formed of a polymer, such as plastic or an elastomer (e.g., rubber, etc.). In one example, snap ring 665 can be formed of metal, such as stainless steel, for instance hardened stainless steel.

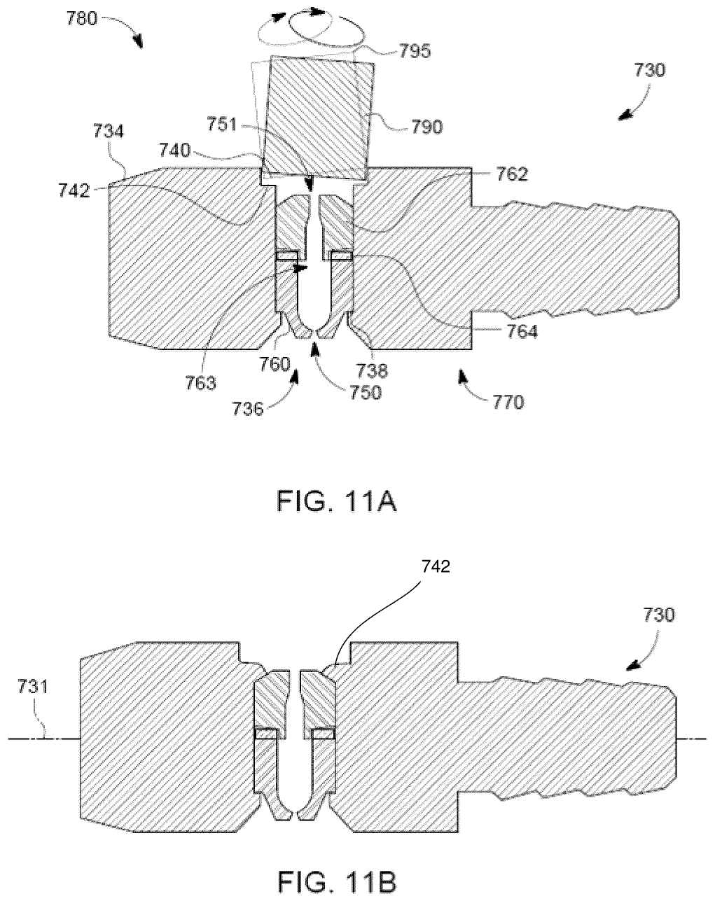

FIGS. 11A and 11B (collectively referred to herein as FIG. 11) are cross-sectional views showing example spray tip 730. As illustrated in FIG. 11, spray tip 730 includes tip stem 734 with a receiving channel 736 provided therein, transverse to the longitudinal axis 731 of the tip stem 734. Receiving channel 736 extends between a front 770 of spray tip 730 and a back 780 of spray tip 730. It can be seen in FIG. 11 that a tip piece 760, a pre-orifice element in the form of a pre-orifice piece 762, and a sealing element 764 are placed within receiving channel 736 from the back 780 of spray tip 730 and are retained within receiving channel 736. The geometry of receiving channel 736 forms a shoulder 738 against which an outer surface of tip piece 760 abuts. Sealing element 764 fits around pre-orifice piece 762 (a portion of pre-orifice piece 762 is disposed within a hole of sealing element 764). Sealing element 764 comprises a ductile or elastomeric material such as a polymer (e.g., acetal, etc.) or various other ductile or elastomeric materials. Sealing element 764 abuts an outer surface of pre-orifice piece 762, abuts an outer surface of tip piece 760, and abuts a wall of receiving channel 736. Tip piece 760 and pre-orifice piece 762 form a fluid channel 763 having variable geometry extending from an inlet 751 to an outlet 750. Fluid, to be sprayed, is received though the inlet 751 and exits through the outlet 750. A recess 740 is provided from and in the back 780 of spray tip 730 which forms an annular wall 742.

A peen tool 790 is provided (as part of an orbital forming machine). Peen tool 790 is used, in an orbital forming process, to deform annular wall 742. Peen tool 790 is pressed, from the back 780 of spray tip 730, against spray tip 730 such that peen tool 790 fits within recess 740, contacts annular wall 742 to deform (or crimp) annular wall 742 against pre-orifice piece 762 (as shown in FIG. 11B). Peen tool 790 is caused to actuate in a circular, or orbital, motion (as indicated by arrow 795) to progressively collapse (deform or crimp) annular wall 742 against pre-orifice piece 762. The deformation (or crimping) of annular wall 742 against pre-orifice piece 762 drives pre-orifice piece 762 to and against sealing element 764 and thereby crushes sealing element 764 such that sealing element 764 forms a seal against an outer surface of pre-orifice piece 762, a seal against an outer surface of tip piece 760, and a seal against a wall of receiving channel 736. The deformed annular wall 742 (shown in FIG. 11B) and the shoulder 738 retain pre-orifice piece 762, sealing element 764, and tip piece 760 within receiving channel 736.

In one example, tip piece 760 can be formed of a metal, such as carbide. In one example, pre-orifice piece 762 can be formed of a metal, such as carbide or stainless steel, such as hardened stainless steel. In one example, sealing element 764 can be formed of a polymer, such as an elastomer (e.g., rubber, etc.).

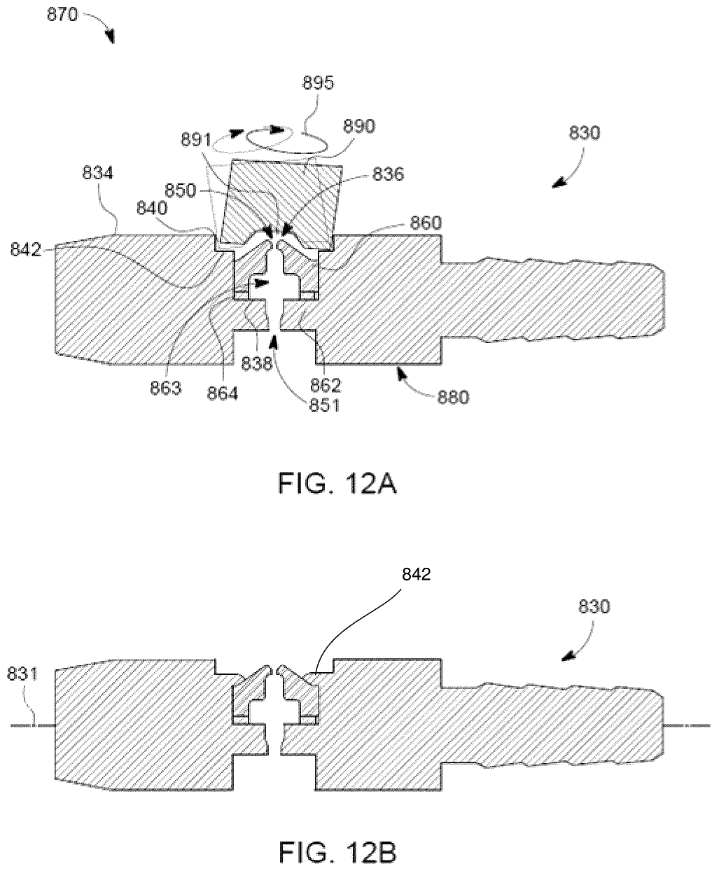

FIGS. 12A and 12B (collectively referred to herein as FIG. 12) are cross-sectional views showing example spray tip 830. As illustrated in FIG. 12, spray tip 830 includes tip stem 834 with a receiving channel 836 provided therein, transverse to the longitudinal axis 831 of the tip stem 834. Receiving channel 836 extends between a front 870 of spray tip 830 to a pre-orifice element in the form of a pre-orifice portion 862. Pre-orifice portion 862 is formed within tip stem 834, such as by machining. It can be seen in FIG. 12 that a tip piece 860 and a sealing element 864 are placed within receiving channel 836 from the front 870 of spray tip 830 and are retained within receiving channel 836. The geometry of receiving channel 836 forms a shoulder 838. Sealing element 864 abuts shoulder 838, an outer surface of tip piece 860, and a wall of receiving channel 836. Sealing element 864 comprises a ductile or elastomeric material such as a polymer (e.g., acetal, etc.) or various other ductile or elastomeric materials. Tip piece 860. sealing element 864, and pre-orifice portion 862 form a fluid channel 863 having variable geometry extending from an inlet 851 to an outlet 850. Fluid, to be sprayed, is received though the inlet 851 and exits through the outlet 850. A recess 840 is provided from and in the front 880 of spray tip 830 which forms an annular wall 842.

A peen tool 890 is provided (as part of an orbital forming machine or other cold forming process). Peen tool 890 is similar to peen tool 790 except that peen tool 890 includes a recess 891 configured to receive a portion of tip piece 860. Peen tool 890 is used, in an orbital forming process, to deform annular wall 842. Peen tool 890 is pressed, from the front 870 of spray tip 830, against spray tip 830 and against tip piece 860 such that peen tool 890 fits within recess 840, contacts annular wall 842 to deform (or crimp) annular wall 842 against tip piece 860 (as shown in FIG. 12B). Peen tool 890 is caused to actuate in a circular, or orbital, motion (as indicated by arrow 895) to progressively collapse (deform or crimp) annular wall 842 against tip piece 860. The deformation (or crimping) of annular wall 842 against tip piece 860 drives tip piece 860 to and against sealing element 864 and thereby crushes sealing element 864 such that sealing element 864 forms a seal against an outer surface of pre-orifice element 862 or shoulder 838, a seal against an outer surface of tip piece 760, and a seal against a wall of receiving channel 836. The deformed annular wall 842 (shown in FIG. 12B) and the shoulder 838 retain tip piece 860 and sealing element 864 within receiving channel 836.

In one example, tip piece 860 can be formed of a metal, such as carbide. In one example, pre-orifice portion 862 can be formed of a metal, such as carbide or stainless steel, such as hardened stainless steel. In one example, sealing element 864 can be formed of a polymer, such as an elastomer (e.g., rubber, etc.).

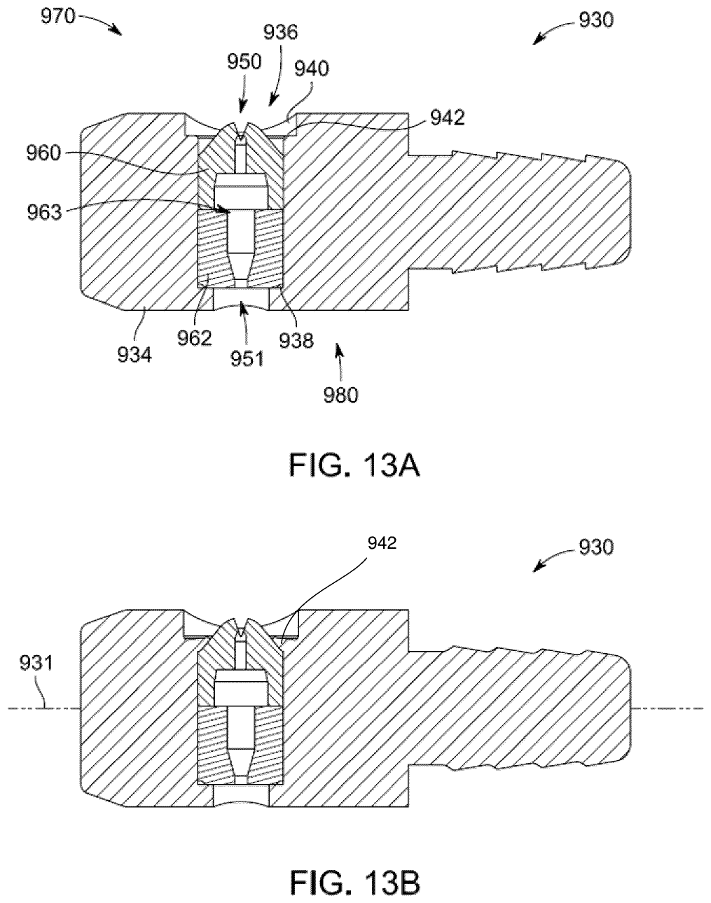

FIGS. 13A and 13B (collectively referred to herein as FIG. 13) are cross-sectional views showing example spray tip 930. As illustrated in FIG. 13, spray tip 930 includes tip stem 934 with a receiving channel 936 provided therein, transverse to the longitudinal axis 931 of the tip stem 934. Receiving channel 936 extends from a front 970 to a back 980 of the spray tip 930. It can be seen in FIG. 13 that a tip piece 960 and a pre-orifice element in the form of a pre-orifice piece 962 are placed within receiving channel 936 from the front 970 of spray tip 930 and are retained within receiving channel 936. The geometry of receiving channel 936 forms a shoulder 938 against which pre-orifice piece 962 abuts. Tip piece 960 and pre-orifice piece 962 form a fluid channel 963 having variable geometry extending from an inlet 951 to an outlet 950. Fluid, to be sprayed, is received through inlet 951 and exits through outlet 950. A recess 940 is provided from and in the front 970 of spray tip 930 which forms an annular wall 942.

Though not shown in FIG. 13, a tool (e.g., swaging tool, peen tool, etc.) can be provided. The tool is pressed, from the front 970 of spray tip 930, against spray tip 930 such that the tool (at least a portion thereof) fits within recess 940 and contacts annular wall 942 to deform (or crimp) annular wall 942 against tip piece 960 (as shown in FIG. 13B). The deformation of annular wall 942 against tip piece 960 drives tip piece 960 to and against pre-orifice piece 962 and drives pre-orifice piece 962 to and against shoulder 938 to further secure and fit tip piece 960 and pre-orifice piece 962 within receiving channel 936 and to better form a seal between tip piece 960 and pre-orifice piece 962 and to better form seals between tip piece 960 and tip stem 934 and pre-orifice piece 962 and tip stem 934. The deformed annular wall 942 (shown in FIG. 13B) and shoulder 938 retain tip piece 960 and pre-orifice piece 962 within receiving channel 936. The axial compression of the annular wall 942 is such that the deformed annular wall 942 is able to retain elements within the receiving channel 936 and to provide a seal between the tip piece 960 and the tip stem 934 (or the deformed annular wall 942 of the tip stem 934). The tool may include one or more components shaped to accommodate a portion of tip piece 960.

In one example, tip piece 960 can be formed of a metal, such as carbide. In one example, pre-orifice piece 962 (as well as tip stem 934) can be formed of stainless steel, such as hardened stainless steel.

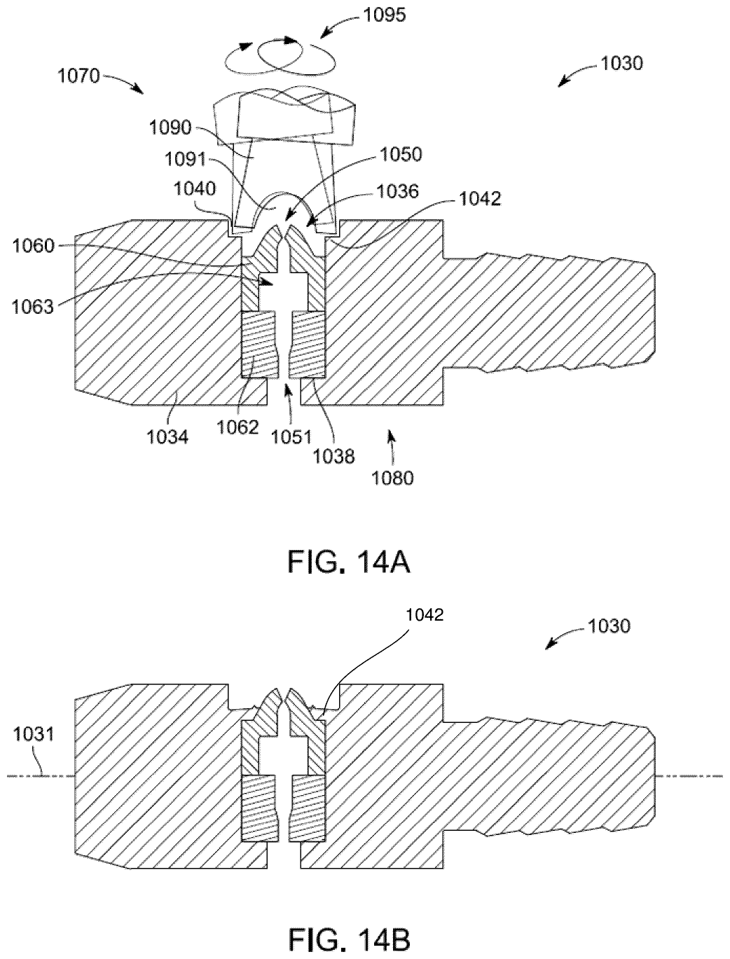

FIGS. 14A and 14B (collectively referred to herein as FIG. 14) are cross-sectional views showing example spray tip 1030. As illustrated in FIG. 14, spray tip 1030 includes tip stem 1034 with a receiving channel 1036 provided therein, transverse to the longitudinal axis 1031 of the tip stem 1034. Receiving channel 1036 extends between a front 1070 and a back 1080 of the spray tip 1030. It can be seen in FIG. 14 that a tip piece 1060 and a pre-orifice element in the form of a pre-orifice piece 1062 are placed within receiving channel 1036 from the front 1070 of spray tip 1030 and are retained within receiving channel 1036. The geometry of receiving channel 1036 forms a shoulder 1038 against which pre-orifice piece 1062 abuts. Tip piece 1060 and pre-orifice piece 1062 form a fluid channel 1063 having variable geometry extending from an inlet 1051 to an outlet 1050. Fluid, to be sprayed, is received through inlet 1051 and exits through outlet 1050. A recess 1040 is provided from and in the front 1070 of spray tip 1030 which forms an annular wall 1042.

A peen tool 1090 is provided (as part of an orbital forming machine or other cold forming process). Peen tool is similar to peen tool 890 and includes a recess 1091 configured to receive a portion of tip piece 1060. Peen tool 1090 is used, in an orbital forming process, to deform annular wall 1042. The peen tool 1090 is pressed, from the front 1070 of spray tip 1030, against spray tip 1030 and against tip piece 1060 such that peen tool 1090 fits within recess 1040 and contacts annular wall 1042 to deform (or crimp) annular wall 1042 against tip piece 1060 (as shown in FIG. 14B). Peen tool 1090 is caused to actuate in a circular, or orbital, motion (as indicated by arrow 1095) to progressively collapse (deform or crimp) annular wall 1042 against tip piece 1060. The deformation (or crimping) of annular wall 1042 drives tip piece 1060 to and against pre-orifice piece 1062 and drives pre-orifice piece to and against shoulder 1038 to further secure and fit tip piece 1060 and pre-orifice piece 1062 within receiving channel 1036 and to better form a seal between tip piece 1060 and pre-orifice piece 1062 and to better form seals between tip piece 1060 and tip stem 1034 and pre-orifice piece 1062 and tip stem 1034. The deformed annular wall 1042 (shown in FIG. 14B) and shoulder 1038 retain tip piece 1060 and pre-orifice piece 1062 within receiving channel 1036. The axial compression of the annular wall 1042 is such that the deformed annular wall 1042 is able to retain elements within the receiving channel 1036 and to provide a seal between the tip piece 1060 and the tip stem 1034 (or the deformed annular wall 1042 of the tip stem 1034). It can be seen that peen tool 1090 includes a recess 1091 to accommodate a portion of tip piece 1060.

In one example, tip piece 1060 can be formed of a metal, such as carbide. In one example, pre-orifice piece 1062 (as well as tip stem 1034) can be formed of stainless steel, such as hardened stainless steel.

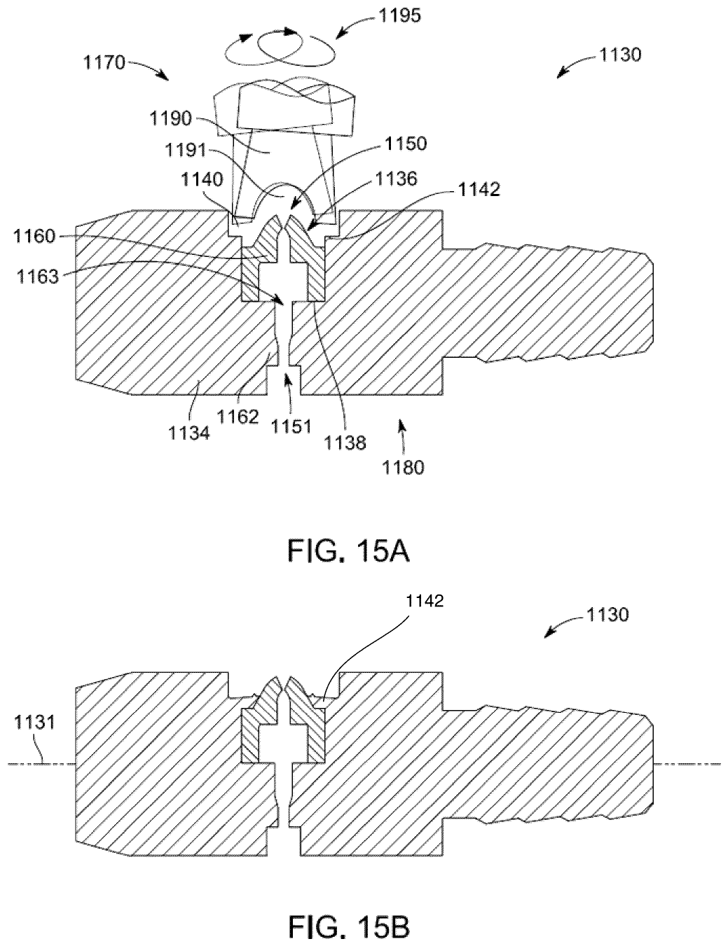

FIGS. 15A and 15B (collectively referred to herein as FIG. 15) are cross-sectional views showing example spray tip 1130. As illustrated in FIG. 15, spray tip 1130 includes tip stem 1134 with a receiving channel 1136 provided therein, transverse to the longitudinal axis 1131 of the tip stem 1134. Receiving channel 1136 extends between a front 1170 of the spray tip 1130 and a pre-orifice element in the form of a pre-orifice portion 1162. Pre-orifice portion 1162 is formed within tip stem 1134, such as by machining. It can be seen in FIG. 15 that a tip piece 1160 is placed within receiving channel 1136 from the front 1170 of spray tip 1130 and is retained within receiving channel 1136. The geometry of receiving channel 1136 forms a shoulder 1138 against which tip piece 1160 abuts. Tip piece 1160 and pre-orifice portion 1162 form a fluid channel 1163 having variable geometry extending from an inlet 1151 to an outlet 1150. Fluid, to be sprayed, is received through inlet 1151 and exits through outlet 1150. A recess 1140 is provided from and in the front 1170 of spray tip 1130 which forms an annular wall 1142.

A peen tool 1190 is provided (as part of an orbital forming machine or other cold forming process). Peen tool is similar to peen tool 1090 and includes a recess 1191 configured to accommodate a portion of tip piece 1160. Peen tool 1190 is used, in an orbital forming process, to deform annular wall 1142. The peen tool 1190 is pressed, from the front 1170 of spray tip 1130, against spray tip 1130 such that peen tool 1190 fits within recess 1140 and contacts annular wall 1142 to deform (or crimp) annular wall 1142 against tip piece 1160 (as shown in FIG. 15B). Peen tool 1190 is caused to actuate in a circular, or orbital, motion (as indicated by arrow 1195) to progressively collapse (deform or crimp) annular wall 1142 against tip piece 1160. The deformation (or crimping) of annular wall 1142 drives tip piece 1160 to and against shoulder 1138 to further secure and fit tip piece 1160 within receiving channel 1136 and to better form a seal between tip piece 1160 and tip stem 1134. The deformed annular wall 1142 (shown in FIG. 15B) and shoulder 1138 retain tip piece 1160 within receiving channel 1136. The axial compression of the annular wall 1142 is such that the deformed annular wall 1142 is able to retain elements within the receiving channel 1136 and to provide a seal between the tip piece 1160 and the tip stem 1134 (or the deformed annular wall 1142 of the tip stem 1134).

In one example, tip piece 1160 can be formed of a metal, such as carbide. In one example, pre-orifice portion 1162 (as well as tip stem 1134) can be formed of stainless steel, such as hardened stainless steel.

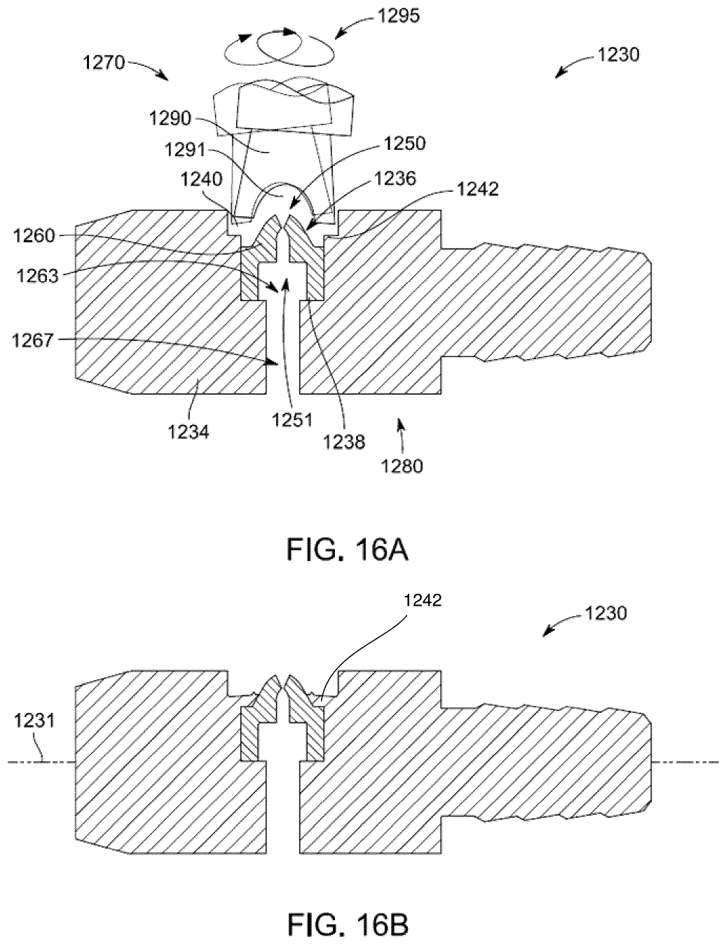

FIGS. 16A and 16B (collectively referred to herein as FIG. 16) are cross-sectional views showing example spray tip 1230. As illustrated in FIG. 16, spray tip 1230 includes tip stem 1234 with a receiving channel 1236 provided therein, transverse to the longitudinal axis 1231 of the tip stem 1234. Receiving channel 1236 extends between a front 1270 of the spray tip 1230 and an inlet channel 1267. Inlet channel 1267 is formed within tip stem 1234, such as by machining. It can be seen in FIG. 16 that a tip piece 1260 is placed within receiving channel 1236 from the front 1270 of spray tip 1230 and is retained within receiving channel 1236. The geometry of receiving channel 1236 forms a shoulder 1238 against which tip piece 1260 abuts. Tip piece 1260 forms a fluid channel 1263 having variable geometry extending from an inlet 1251 to an outlet 1250. Fluid, to be sprayed, is received through inlet 1251 and exits through outlet 1250. A recess 1240 is provided from and in the front 1270 of spray tip 1230 which forms an annular wall 1242.

A peen tool 1290 is provided (as part of an orbital forming machine or other cold forming process). Peen tool is similar to peen tool 1190 and includes a recess 1291 configured to receive a portion of tip piece 1260. Peen tool 1290 is used, in an orbital forming process, to deform annular wall 1242. The peen tool 1290 is pressed, from the front 1270 of spray tip 1230, against spray tip 1230 such that peen tool 1290 fits within recess 1240 and contacts annular wall 1242 to deform (or crimp) annular wall 1242 against tip piece 1260 (as shown in FIG. 16B). Peen tool 1290 is caused to actuate in a circular, or orbital, motion (as indicated by arrow 1295) to progressively collapse (deform or crimp) annular wall 1242 against tip piece 1260. The deformation (or crimping) of annular wall 1242 drives tip piece 1260 to and against shoulder 1238 to further secure and fit tip piece 1260 within receiving channel 1236 and to better form a seal between tip piece 1260 and tip stem 1234. The deformed annular wall 1242 (shown in FIG. 16B) and shoulder 1238 retain tip piece 1260 within receiving channel 1236. The axial compression of the annular wall 1242 is such that the deformed annular wall 1242 is able to retain elements within the receiving channel 1236 and to provide a seal between the tip piece 1260 and the tip stem 1234 (or the deformed annular wall 1242 of the tip stem 1234).

In one example, tip piece 1260 can be formed of a metal, such as carbide. In one example, tip stem 1234 can be formed of stainless steel, such as hardened stainless steel.

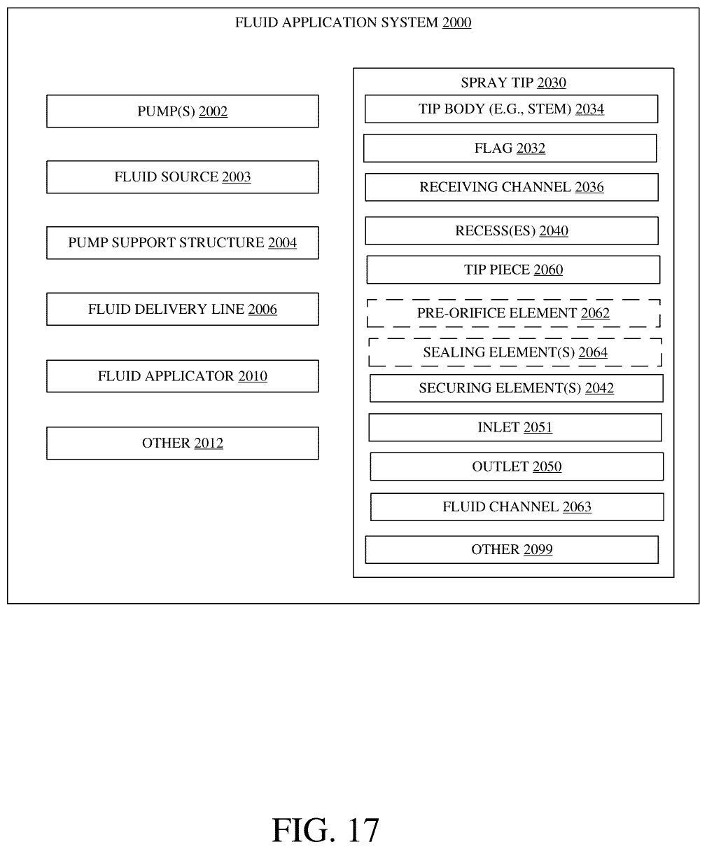

FIG. 17 is a block diagram showing one example fluid application system 2000. Fluid application system 2000 can include one or more pumps 2002, a fluid source 2003, a pump support structure 2004, a fluid delivery line 2006, a fluid applicator 2010, a spray tip 2030, and can include various other items 2012, including, but not limited to, other items discussed or shown herein. One example of fluid application system is fluid application system 1, shown in FIG. 1.

Pumps 2002, in one example, can be similar to pump 2, or can be other type of pumps. A fluid source 2003 can be a fluid container, such as a paint bucket (e.g., 5-gallon paint bucket, etc.). Pump support structure 2004 can be similar to or the same as cart 4 or can be other types of pump support structures. Fluid delivery line 2006 can be similar to fluid delivery line 6 or can be another type of fluid delivery line. Fluid applicator 2010 can be similar to fluid applicator 10 or can be another type of fluid applicator. Pumps 2002 pump and pressurize fluid from fluid source 2003 and deliver the pressurized fluid to fluid applicator 2010 via fluid delivery line 2006. The pumps 2002 can be supported by a pump support structure 2004, such as a cart (e.g., 4) or other pump support structure.

Spray tip 2030 is installed in fluid applicator 2010. Spray tip 2030 can be similar to spray tip 30, spray tip 130, spray tip 230, spray tip 330, spray tip 430, spray tip 530, spray tip 630, spray tip 730, spray tip 830, spray tip 930, spray tip 1030, spray tip 1130, or spray tip 1230, or can be another type of spray tip. Pressurized fluid is delivered through fluid applicator to spray tip 2030. Spray tip 2030 breaks up, or atomizes, the fluid to deliver the fluid in a desired spray pattern.

Spray tip 2030 can include a tip body (e.g., stem, etc.) 2034, a flag 2032, a receiving channel 2036, one or more recesses 2040, a tip piece 2060, one or more securing elements 2042, an outlet 2050, an inlet 2051, and a fluid channel 2063. In some examples, spray tip 2030 can also include a pre-orifice element 2062 or one or more sealing elements 1064, or both. Spray tip 2030 can include various other items 1099 as well, including but not limited to, other items discussed or shown herein.

Tip body (or stem) 2034 can be similar to stem 34, stem 134, stem 234, stem 334, stem 434, stem 534, stem 634, stem 734, stem 834, stem 934, stem 1034, stem 1134, or stem 1234, or can be another type of tip body (e.g., stem, etc.). Flag 2032 can be similar to flag 32 or can be another type of flag. Receiving channel 2036 can be similar to receiving channel 36, receiving channel 136, receiving channel 236, receiving channel 336, receiving channel 436, receiving channel 536, receiving channel 636, receiving channel 736, receiving channel 836, receiving channel 936, receiving channel 1036, receiving channel 1136, or receiving channel 1236, or can be another type of receiving channel.

Recesses 2040 can be similar to recess 140, recess 240, recess 440, recess 540, recess 640, recess 740, recess 840, recess 940, recess 1040, recess 1140, or recess 1240, or can be another type of recess or other types of recesses.

Tip piece 2060 can be similar to tip piece 60, tip piece 160, tip piece 260, tip piece 360, tip piece 460, tip piece 560, tip piece 660, tip piece 760, tip piece 860, tip piece 960, tip piece 1060, tip piece 1160, or tip piece 1260, or can be another type of tip piece. Pre-orifice element 1062 can be similar to pre-orifice piece 162, pre-orifice portion 262, pre-orifice piece 362, pre-orifice piece 462, pre-orifice piece 562, pre-orifice piece 662, pre-orifice piece 762, pre-orifice portion 862, pre-orifice piece 962, pre-orifice piece 1062, pre-orifice portion 1162, or can be another type of pre-orifice element. Sealing elements 2064 can be similar to sealing element 164, sealing element 264, sealing element 364, sealing element 464, sealing element 564, sealing element 664, sealing element 764, or sealing element 864, or can be another type of sealing element or other types of sealing elements.

Securing elements 2042 can be similar to shoulder 138 and deformed projections 142, to shoulder 238 and deformed projections 242, to mating threads 363, mating threads 337 and shoulder 338, to shoulder 438, shoulder 443, and deformed wall 442, to shoulder 538, shoulder 543, and ring 565, to shoulder 638, shoulder 643, and ring 665, to shoulder 738 and deformed wall 742, to shoulder 838 and deformed wall 842, to shoulder 938 and deformed wall 942, to shoulder 1038 and deformed wall 1042, to shoulder 1138 and deformed wall 1142, or to shoulder 1238 and deformed wall 1242, or another type of securing element or other types of securing elements.

Outlet 2050 can be similar to outlet 50, outlet 150, outlet 250, outlet 350, outlet 450, outlet 550, outlet 650, outlet 750, outlet 850, outlet 950, outlet 1050, outlet 1150, or outlet 1250, or another type of outlet. Inlet 2051 can be similar to inlet 151, inlet 251, inlet 351, inlet 451, inlet 551, inlet 651, inlet 751, inlet 851, inlet 951, inlet 1051, inlet 1151, or inlet 1251, or can be another type of inlet. Fluid channel 2063 can be similar to fluid channel 136, fluid channel 236, fluid channel 336, fluid channel 436, fluid channel 536, fluid channel 636, fluid channel 736, fluid channel 836, fluid channel 936, fluid channel 1036, fluid channel 1136, or fluid channel 1236, or another type of fluid channel. Fluid channel 2063 extends between inlet 2051 and outlet 2050 and can have variable geometry. In some examples, fluid channel 2063 can be stepped, or can otherwise progressively widen from an upstream end to a downstream point and then progressively narrow from the downstream point to a downstream end.

It will be understood that spray tip 2030 can be reversible (e.g., can be rotated about its longitudinal axis). That is, the spray tip can be rotated between a first operating posture (normal operation posture) in which the outlet 2050 is facing away from the applicator 2010 and inlet 2051 is facing towards the applicator 2010 and a second operating posture (cleaning operation posture) in which the outlet 2050 is facing towards the applicator 2010 and the inlet 2051 is facing away from the applicator 2010.

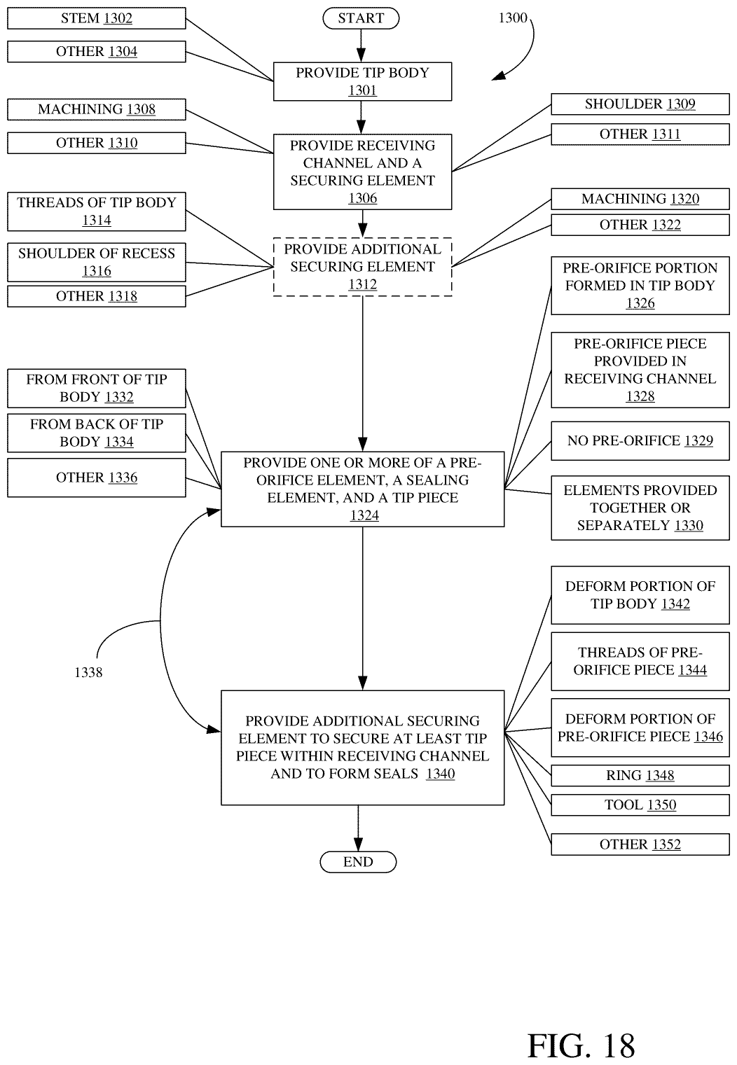

FIG. 18 shows a flowchart showing one example method 1300 of manufacturing a spray tip, such as spray tip 2030.

At block 1301 a tip body 2034 is provided. As indicated by block 1302, the tip body 2034 can be a stem, such as stem 34, stem 134, stem 234, stem 334, stem 434, stem 534, stem 634, stem 734, stem 834, stem 934, stem 1034, stem 1134, or stem 1234, or another type of stem. The tip body 2034 can be other types of tip bodies, as indicated by block 1304.

At block 1306, a receiving channel 2036 and a securing element 2042 is provided in tip body 2034. The receiving channel 2036 can be receiving channel 36, receiving channel 136, receiving channel 236, receiving channel 336, receiving channel 436, receiving channel 536, receiving channel 636, receiving channel 736, receiving channel 836, receiving channel 936, receiving channel 1036, receiving channel 1136, or receiving channel 1236, or another type of receiving channel. In some examples, the receiving channel 2036 is transverse to a longitudinal axis of the tip body 2034. The securing element 2042 at block 1306 can be shoulder 138, shoulder 238, shoulder 338, shoulder 438, shoulder 538, shoulder 638, shoulder 738, shoulder 838, shoulder 938, shoulder 1038, shoulder 1138, or shoulder 1238, or can be another type of securing element. In some examples, providing the receiving channel 2036 also provides the securing element 2042 at block 1306, for instance, the geometry of the receiving channel 2036 may define the securing element 2042 at block 1306. As indicated by block 1308, the receiving channel 2036 or the securing element 2042, at block 1306, can be provided by machining. As indicated by block 1310, the receiving channel 2036 or the securing element 2042, at block 1306, can be provided in various other ways.

In some examples, an additional securing element 2042 is provided at block 1312. As indicated by block 1314, the additional securing element 2042 can be threads formed in the tip body 2034. The threads can be threads 337, or can be other threads. As indicated by block 1316, the additional securing element 2042 can be a shoulder of a recess formed in the tip body 2034. The shoulder of the recess can be shoulder 443 of recess 440, shoulder 543 of recess 540, or shoulder 643 of recess 640, or can be another shoulder of another recess. The additional securing element 2042 can be various other securing elements, as indicated by block 1318. As indicated by block 1320, the additional securing element 2042 can be provided by machining. As indicated by block 1322, the additional securing element 2042 can be provided in various other ways.

At block 1324 one or more of a pre-orifice element 2062, a sealing element 2064, and a tip piece 2060 is provided. For instance, in some examples, a pre-orifice element 2062, and sealing element 2064, and a tip piece 2060 are provided. In other examples, a pre-orifice element 2062 and a tip piece 2060 are provided. In yet other examples, a tip piece 2060 is provided.

In one example, as indicated by block 1326, providing the pre-orifice element 2062 can comprise forming (e.g., by machining, etc.) the pre-orifice element 2062 in the tip body 2034, such as the example pre-orifice portion 262 in the tip stem 234 in FIG. 6, the example pre-orifice portion 862 in the tip stem 834 in FIG. 12, or the example pre-orifice portion 1162 in the tip stem 1134 in FIG. 15. In such examples, providing the sealing element 2064 or providing the tip piece 2060, or both, can comprise placing the sealing element 2064 or the tip piece 2060, or both, into the receiving channel 2036 (from the front of the tip body as indicated by block 1332). In such examples, the tip piece 2060 is upstream of the pre-orifice element 2062 or the sealing element 2064 (or at least a portion of the tip piece 2060 is upstream of the sealing element 2064), or both. In examples, at block 1326, where a sealing element 2064 is provided, the sealing element 2064 is upstream of the pre-orifice element 2062, or at least a portion of the pre-orifice element 2062. At block 1326, the pre-orifice element 2062, or at least a portion of the pre-orifice element 2062, is upstream of the receiving channel 2036.

In one example, as indicated by block 1328, providing the pre-orifice element 2062 can comprise placing the pre-orifice element 2062 in the receiving channel 2036, such as the example pre-orifice pieces 162, 362, 462, 562, 662, 762, 962, and 1062 in FIGS. 5 and 7-11, and 13-14, respectively. In such examples, providing can comprise placing the sealing element 2064 or the tip piece 2060, or both, into the receiving channel 2036 (from the front of the tip body as indicated by block 1332 or from the back of the tip body as indicated by block 1334). In such examples, the tip piece 2060 is upstream of the pre-orifice element 2062 or the tip piece 2060 is upstream of the pre-orifice element 2062 and the tip piece 2060, or at least a portion of the tip piece 2060, is upstream of the sealing element 2064. In examples where a sealing element 2064 is provided, the sealing element 2064 is upstream of the pre-orifice element 2062, or at least a portion of the pre-orifice element 2062. For instance, in some examples, the sealing element 2064 may be disposed around the pre-orifice element 2062 such that a portion of the pre-orifice element 2062 is disposed in a hole of the sealing element 2064. In such examples, the pre-orifice element 2062, or at least a portion of the pre-orifice element 2062, is downstream, at least partially, of the sealing element 2064.

In some examples, no pre-orifice element 2062 is provided, as indicated by block 1329. For instance, instead another element may be provided in the tip 2030 (e.g., tip body 2034), such as an inlet channel. One example of an inlet channel is inlet channel 1267 in FIG. 16. Other elements, including other types of inlet channels, can be provided.

In some examples, two or more of the pre-orifice element 2062, the sealing element 2064, and the tip piece 2060 may be provided together (e.g., placed in the receiving channel 2036 together), as indicated by block 1330. For instance, the sealing element 2064 and the pre-orifice element 2062 can, in some examples, be provided together (e.g., placed in the receiving channel 2036 together). For instance, the sealing element 2064 may be fit around a portion of the pre-orifice element 1062 and then the sealing element 2064 and the pre-orifice element 2062 may be provided together (e.g., placed in the receiving channel 2036 together). For instance, in the examples shown in FIGS. 5 and 11, the sealing element 2064 and the pre-orifice element 2062 may be provided together (e.g., placed in the receiving channel 2036 together). Of course, in some instances, the sealing element 2064 and the pre-orifice element 2062 need not be provided together. For instance, the sealing element 2064 and the pre-orifice element 2062 need not be provided together in the examples shown in FIGS. 5 and 11.

In some examples, the pre-orifice element 2062 (if provided at all), the sealing element 2064 (if provided at all), and the tip piece 2060 may be provided separately. For instance, in the examples shown in FIGS. 6-10 and 12, the pre-orifice element 2062, the sealing element 2064, and the tip piece 2060 may be provided separately. Of course, as will be noted, in some examples (e.g., FIG. 16) only a tip piece 2060 is provided. In some examples (FIGS. 13-15), only a tip piece 2060 and a pre-orifice element 2062 are provided. It will be noted that while the examples shown in FIGS. 13-16 do not include a sealing element 2064, in some instances, a sealing element 2064 may additionally be provided (e.g., at least partially, between the pre-orifice element 2062 and the tip piece 2060 or at least partially between the tip piece 2060 and another element (e.g., securing element 2042)) in the examples shown in FIGS. 13-16.

The pre-orifice element 2062 (if provided at all), the sealing element 2064 (if provided at all), and the tip piece 2060 may be provided in various other ways, as indicated by block 1336.

At block 1340 an additional securing element 2042 is provided to secure at least tip piece 2060 within receiving channel 2036 and to form seals. Of course, in some examples, the additional securing element 2042 is provided to secure the tip piece 2060 as well as the pre-orifice element 2062 or a sealing element 2064, or both, within receiving channel 2036 and to form seals. In some examples, the additional securing element 2042 is provided to secure the pre-orifice element 2062, the sealing element 2064, and the tip piece 2060 in the receiving channel 2036, such as in the examples shown in FIGS. 5 and 7-11 (e.g., examples where the pre-orifice element 2062 is a pre-orifice piece, such as pre-orifice piece 162, pre-orifice piece 362, pre-orifice piece 462, pre-orifice piece 562, pre-orifice piece 662, or pre-orifice piece 762, respectively). In some examples, the additional securing element 2042 is provided to secure the pre-orifice element 2062 and the tip piece 2060 in the receiving channel 2036, such as the examples shown in FIGS. 13-14 (e.g., examples where the pre-orifice element 2062 is a pre-orifice piece, such as pre-orifice piece 962 or pre-orifice piece 1062). In some examples, the additional securing element 2042 is provided to secure only the tip piece 2060 and the sealing element 2064 in the receiving channel 2036, such as in the examples shown in FIG. 6 and FIG. 12 (e.g., examples where the pre-orifice element 2062 is a pre-orifice portion formed in the tip body 2034, such as pre-orifice portion 262 and pre-orifice portion 862, respectively). In some examples, the additional securing element 2042 is provided to secure only the tip piece 2060 in the receiving channel 2036, such as in the example shown in FIGS. 15-16 (e.g., examples where there is no sealing element 2064 and the pre-orifice element 2062 is a pre-orifice portion formed in the tip body 2034, such as pre-orifice portion 1162 or examples where there is no sealing element 2064 and no pre-orifice element 2062 (e.g., FIG. 16)). In examples in which a sealing element 2064 is provided, providing the additional securing element 2042 causes the formation of seals.

For example, providing the additional securing element 2042 can cause the formation of seals by causing compression of sealing element 2064 (e.g., by driving movement of the tip piece 2060 or the pre-orifice element 2062 to reduce the distance between the tip piece 2060 and the pre-orifice element 2062). The seals can include two or more of a seal between sealing element 2064 and pre-orifice element 2062, a seal between sealing element 2064 and tip piece 2060, and a seal between sealing element 2064 and tip body 2034.

Additionally, or alternatively, providing the additional securing element can cause the formation of seals between the tip piece 2060 and the pre-orifice element 2062 (e.g., by causing compression of tip piece 2060 or the pre-orifice element 2062 to reduce the distance between the tip piece 2060 and the pre-orifice element 2062). The seals can include two or more of a seal between tip piece 2060 and the pre-orifice element 2062, a seal between the tip piece 2060 and the tip body 2034, and a seal between the pre-orifice element 2062 and the tip body 2034.

In some examples, providing the additional securing element can cause the formation of seals between tip piece 2060 and the tip body 2034 (e.g., by causing compression of tip piece 2060 to reduce the distance between the tip piece and the tip body 2034).

In some examples, providing the additional securing element 2042 at block 1340 can comprise deforming a portion of the tip body 2034, as indicated by block 1342, such as in the examples of deformed projections 142 and 242 shown in FIGS. 5 and 6, respectively, and in the examples of deformed walls 742, 842, 942, 1042, 1142, and 1242 shown in FIGS. 11 12, 13, 14, 15, and 16 respectively. Deforming a portion of the tip body 2034 can include a forming process such as a radial forming process, an orbital forming, a cold forming process, or various other forming processes and may include use of a tool, such as, but not limited to, one of the tools shown herein and described again at block 1350.

In some examples, as indicated by block 1344, providing the additional securing element 2042 at block 1340 can comprise providing threads of a pre-orifice element 2062, such as in the example of threads 363 of pre-orifice piece 336 shown in FIG. 6. In such an example, the threads of the pre-orifice element 2062 are mated with threads of the tip body 2034 (e.g., threads 337) such as those provided at block 1314. The pre-orifice element 2062 is thus threadably coupled to the tip body 2034 and acts as an additional securing element 2042 to secure pre-orifice portion 2062, tip piece 2060, and, if included, sealing element 2064 in the receiving channel 2036. Thus, providing the pre-orifice portion 2062 and the additional sealing element 2042 at block 1340 can occur together as indicated by arrow 1338.

In some examples, providing the additional securing element 2042 at block 1340 can comprise deforming a portion of the pre-orifice element 2062, as indicated by block 1346, such as in the example of deformed wall 442 shown in FIG. 8. In such an example, the deformed portion of pre-orifice element 2062 may be deformed to be disposed within a recess (e.g., recess 440) of the tip body 2034 and to be disposed against another securing element 2042, such as a shoulder of the tip body 2034 (e.g., shoulder 443) such as the shoulder of the recess provided at block 1316.

In some examples, providing the additional securing element 2042 at block 1340 can comprise providing a ring, as indicated by block 1348, such as in the example of ring 565 and ring 665 show in FIGS. 9 and 10, respectively. In one example, the ring (e.g., ring 565) is moveable between a first diameter and a second diameter. The ring is caused to compress to the first, smaller diameter, until aligned with a recess (e.g., recess 540) wherein the ring will snap back to its second, larger diameter, to be disposed in the recess and disposed against another securing element 2042, such as a shoulder of the tip body (e.g., shoulder 543) such as the shoulder of the recess provided at block 1316. In another example, a portion (e.g., wall 667) of the ring (e.g., ring 665) is deformed to be disposed with a recess (e.g., recess 640) of the tip body 2034 and to be disposed against another securing element 2042, such as a shoulder of the tip body 2034 (e.g., shoulder 643) such as the shoulder of the recess provided at block 1316.

Providing the additional securing element 2042 at block 1340 can include the use of a tool, as indicated by block 1350, such as a swaging tool (e.g., swaging tool 190 or swaging tool 290), a rotatable driving tool (e.g., rotatable driving tool 390), a press tool (e.g., press tool 490, press tool 590, or press tool 690), a peen tool (e.g., peen tool 790, peen tool 890, peen tool 1090, peen tool 1190, or peen tool 1290), or another type of tool.

Providing the additional securing element 2060 to secure at least the tip piece 2060 (and in some examples also the sealing element 2064 or the pre-orifice element 2062, or both) within the receiving channel 2036 and to form seals at block 1340 can be done in various other ways, as indicated by block 1352.

As can be seen, a spray tip can include a tip body (e.g., tip stem, etc.) having a longitudinal axis and a receiving channel, formed in the tip stem transverse to the longitudinal axis. The spray tip can further include a tip piece disposed within the receiving channel. In some examples, the tip piece further includes a sealing element disposed within the receiving channel and upstream of the tip piece or a pre-orifice element upstream of the tip piece, or both. The spray tip can also include a fluid channel of variable geometry extending between an upstream end and a downstream end (e.g., between an upstream end of the pre-orifice element and a downstream end of the tip piece or between an upstream end of the tip piece and a downstream end of the tip piece). The spray tip can further include a first securing element downstream of the tip piece, or at least a portion of the tip piece. In some example, the first securing element can also be downstream of a sealing element or downstream of a pre-orifice element, or both. The spray piece can further include a second securing element upstream of the tip piece. In some examples, the second securing element can be downstream of a sealing element, or at least a portion of the sealing element, or upstream of a pre-orifice element, or both In one example, a sealing element forms a portion of the fluid channel. In one example, the first securing element comprises a shoulder of the tip body defined by the receiving channel. In one example, the first securing element comprises a deformed portion of the tip body. In one example, the second securing element comprises a shoulder of the tip body defined by the receiving channel. In one example, the second securing element comprises a deformed portion of the tip body. In one example, the second securing element comprises a ring. In one example, the second securing element comprises threads of the pre-orifice element and threads of the tip body. In one example, the second securing element comprises a deformed portion of the pre-orifice element. In one example, the tip body includes a recess extending radially from the receiving channel, the recess configured to receive the second securing element. In one example, the recess includes a shoulder. In one example, the second securing element abuts the shoulder of the recess. In one example, the pre-orifice element comprises hardened stainless steel. In one example, the receiving channel includes threads and the pre-orifice element includes threads, the threads of the pre-orifice element and the threads of the receiving channel being configured to mate. In one example, the pre-orifice element comprises a set screw. In one example, the pre-orifice element is configured to receive a press tool to deform the portion of the pre-orifice element to form the second securing element. In one example, the pre-orifice element is configured to receive a rotatable drive tool. In one example, the pre-orifice element is configured to receive a biased element of a swaging tool. In one example, the tip piece is configured to receive a biased element of a swaging tool. In one example, the tip body is configured to receive a swaging tool to deform the portion of the tip body to form the first securing element. In one example, the tip body is configured to receive a swaging tool to deform the portion of the tip body to form the second securing element. In one example, the second securing element is configured to receive a press tool to cause the second securing element (e.g., ring, portion of pre-orifice element) to be disposed in a recess and to abut a shoulder of the recess. In one example, the tip body is configured to receive a peen tool to deform the portion of the tip body to form the second securing element. In one example, the, the tip body is configured to receive a peen tool to deform the portion of the tip body to form the first securing element.

Although the present invention has been described with reference to preferred examples, workers skilled in the art will recognize that changes may be made in form and detail without departing from the spirit and scope of the invention.

Additionally, while a particular order of steps has been described for the sake of illustration, it is to be understood that some or all of these steps can be performed in any number of orders.

It should also be noted that the different examples described herein can be combined in different ways. That is, parts of one or more examples can be combined with parts of one or more other examples. All of this is contemplated herein.

What is claimed is:

1. A spray tip comprising:
a tip body having a longitudinal axis;
a receiving channel extending between a front and a back of the tip body transverse to the longitudinal axis;
a tip piece defining, at least, a first portion of a fluid channel, the fluid channel extending from an inlet to an outlet;
a first securing element downstream of at least a portion of the tip piece; and
a second securing element upstream of the tip piece, wherein the first securing element and the second securing element secure at least the tip piece within the receiving channel.

2. The spray tip of claim 1 and further comprising a pre-orifice element, wherein the pre-orifice element comprises a pre-orifice piece, the pre-orifice piece disposed in the receiving channel upstream of the tip piece and defining a second portion of the fluid channel, and wherein the first securing element and the second securing element secure the tip piece and the pre-orifice piece in the receiving channel.

3. The spray tip of claim 2, wherein the first securing element compresses the tip piece against the pre-orifice piece.

4. The spray tip of claim 1 and further comprising a pre-orifice element, wherein the pre-orifice element comprises a pre-orifice portion formed in the tip body and upstream of the receiving channel and defines a second portion of the fluid channel.

5. The spray tip of claim 1, wherein the second securing element comprises a shoulder of the tip body.

6. The spray tip of claim 5, wherein the first securing element compresses the tip piece against the second securing element.

7. The spray tip of claim 6 and further comprising a fluid inlet extending between the back of the tip body and the receiving channel.

8. The spray tip of claim 1, wherein the first securing element comprises a deformed portion of the tip body.

9. A fluid application system comprising:
a fluid applicator;
a fluid delivery line coupled to the fluid applicator;
a pump configured to deliver fluid from a fluid source through the fluid delivery line to the fluid applicator; and
a reversible spray tip coupled to the fluid applicator, the spray tip comprising:
a tip body having a longitudinal axis;
a receiving channel extending between a front and a back of the tip body transverse to the longitudinal axis;
a tip piece defining, at least, a first portion of a fluid channel, the fluid channel extending from an inlet to an outlet;
a first securing element downstream of at least a portion of the tip piece; and
a second securing element upstream of the tip piece, wherein the first securing element and the second securing element secure at least the tip piece within the receiving channel.

10. The fluid applicator of claim 1, wherein the reversible spray tip further comprises a pre-orifice element, wherein the pre-orifice element comprises a pre-orifice piece, the pre-orifice piece disposed in the receiving channel upstream of the tip piece and defining a second portion of the fluid channel, and wherein the first securing element and the second securing element secure the tip piece and the pre-orifice piece in the receiving channel.

11. The fluid applicator of claim 10, wherein the first securing element compresses the tip piece against the pre-orifice piece.

12. The fluid applicator of claim 9, wherein the reversible spray tip further comprises a pre-orifice element, wherein the pre-orifice element comprises a pre-orifice portion formed in the tip body and upstream of the receiving channel and defines a second portion of the fluid channel.

13. The fluid applicator of claim 9, wherein the second securing element comprises a shoulder of the tip body.

14. The fluid applicator of claim 13, wherein the first securing element compresses the tip piece against the second securing element.

15. The fluid applicator of claim 14, wherein the reversible spray tip further comprises a fluid inlet extending between the back of the tip body and the receiving channel.

16. The fluid applicator of claim 9, wherein the first securing element comprises a deformed portion of the tip body.

17. A method of manufacturing a spray tip comprising:
providing a tip body having a longitudinal axis;
providing a receiving channel in the tip body transverse to the longitudinal axis, wherein providing the receiving channel provides a securing element;
providing a tip piece, wherein providing the tip piece comprises providing the tip piece within the receiving channel; and
providing an additional securing element, wherein providing the additional securing element drives movement of at least the tip piece to form a seal.

18. The method of claim 17, wherein providing the additional securing element comprises deforming a portion of the tip body.

19. The method of claim 17 and further comprising:
providing a pre-orifice element, wherein providing the pre-orifice element comprises providing the pre-orifice element within the receiving channel upstream of the tip piece; and
wherein providing the additional securing element drives the tip piece against the pre-orifice element.

20. The method of claim 17 and further comprising:
providing a pre-orifice element, wherein providing the pre-orifice element comprising forming the pre-orifice element in the tip body, the pre-orifice element upstream of the receiving channel; and
wherein providing the additional securing element drives the tip piece against the securing element.
